(19) United States
(12) Patent Application Publication
(10) Pub. No.: US 2009/0080124 A1
(43) Pub. Date: Mar. 26, 2009

(54) MAGNETORESISTIVE ELEMENT AND MAGNETORESISTIVE RANDOM ACCESS MEMORY INCLUDING THE SAME

(75) Inventors: Masatoshi Yoshikawa, Yokohama-Shi (JP); Tadaomi Daibou, Kawasaki-Shi (JP); Eiji Kitagawa, Sagamihara-Shi (JP); Toshihiko Nagase, Sagamihara-Shi (JP); Tatsuya Kishi, Yokohama-Shi (JP); Hiroaki Yoda, Sagamihara-Shi (JP)

Correspondence Address: OBLON, SPIVAK, MCCLELLAND MAIER & NEUSTADT, P.C., 1940 DUKE STREET, ALEXANDRIA, VA, 22314, US

(73) Assignee: KABUSHIKI KAISHA TOSHIBA, Tokyo (JP)

(21) Appl. No.: 12/210,496

(22) Filed: Sep. 15, 2008

(30) Foreign Application Priority Data
Sep. 25, 2007 (JP) 2007-248247

(51) Int. Cl. G11B 5/127

(52) U.S. Cl. 360/324.12; G9B/5.04

(57) ABSTRACT

A magnetoresistive element includes: a first magnetization reference layer having magnetization perpendicular to a film plane, a direction of the magnetization being invariable in one direction; a magnetization free layer having magnetization perpendicular to the film plane, a direction of the magnetization being variable; a first intermediate layer provided between the first magnetization reference layer and the magnetization free layer; a magnetic phase transition layer provided on an opposite side of the magnetization free layer from the first intermediate layer, the magnetic phase transition layer being magnetically coupled to the magnetization free layer, and being capable of bidirectionally performing a magnetic phase transition between an antiferromagnetic material and a ferromagnetic material; and an excitation layer provided on an opposite side of the magnetic phase transition layer from the magnetization free layer, and causing the magnetic phase transition layer to perform the magnetic phase transition from the antiferromagnetic material to the ferromagnetic material.

### CROSS-REFERENCE TO RELATED APPLICATION

This application is based upon and claims the benefit of priority from prior Japanese Patent Application No. 2007-248247 filed on Sep. 25, 2007 in Japan, the entire contents of which are incorporated herein by reference.

### BACKGROUND OF THE INVENTION

1. Field of the Invention

The present invention relates to a magnetoresistive element and a magnetoresistive random access memory including the magnetoresistive element.

2. Related Art

In recent years, a number of solid-state memories that record information have been suggested on the basis of novel principles. Among those solid-state memories, magnetoresistive random access memories (hereinafter also referred to as MRAMs) that take advantage of tunneling magneto resistance (hereinafter also referred to as TMR) have been known as solid-state magnetic memories. Each MRAM includes magnetoresistive elements (hereinafter also referred to as MR elements) that exhibit magnetoresistive effects as the memory elements of memory cells, and the memory cells store information in accordance with the magnetization states of the MR elements.

Each MR element includes a magnetization free layer having a magnetization where a magnetization direction is variable, and a magnetization reference layer having a magnetization of which a direction is invariable. When the magnetization direction of the magnetization free layer is parallel to the magnetization direction of the magnetization reference layer, the MR element is put into a low resistance state. When the magnetization direction of the magnetization free layer is antiparallel to the magnetization direction of the magnetization reference layer, the MR element is put into a high resistance state. The difference in resistance is used in storing information.

As a method of writing information on such a MR element, a so-called current-field write method has been known. By this method, a line is placed in the vicinity of the MR element, and the magnetization of the magnetization free layer of the MR element is reversed by the magnetic field generated by the current flowing through the line. When the size of the MR element is reduced to form a small-sized MRAM, the coercive force Hc of the magnetization free layer of the MR element becomes larger. Therefore, in a MRAM of the current-field write type, the current required for writing tends to be larger, since the MRAM is small-sized. As a result, it is difficult to use a low current and small-sized memory cells designed to have capacity larger than 256 Mbits.

As a write method designed to overcome the above problem, a write method that utilizes spin momentum transfers (SMT) (a spin-transfer-torque writing method) has been suggested (see U.S. Pat. No. 6,256,223). By the spin-transfer-torque writing method, a current is applied in a direction perpendicular tQ the film plane of each of the films forming a MR element having a tunneling magnetoresistive effect, so as to change (reverse) the magnetization state of the MR element.

In a magnetization reversal caused by spin injection, the current Ic required for the magnetization reversal is determined by the current density Jc. Accordingly, as the area of the face on which the current flows becomes smaller in a MR element, the injection current Ic required for reversing the magnetization becomes smaller. In a case where writing is performed with fixed current density, the current Ic becomes smaller, as the size of the MR element becomes smaller. Accordingly, the spin-transfer-torque writing method provides excellent scalability in principle, compared with the field write method.

However, in a case where a MRAM is designed to utilize the spin-transfer-torque writing method, the current required for causing a magnetization reversal in the magnetization free layer having a sufficient magnetization reversal energy for retaining information is larger than the current value that can be generated by a selective transistor that is often used in the formation of conventional MRAMs. Because of this, such a MRAM cannot be operated as a memory in practice.

### SUMMARY OF THE INVENTION

The present invention has been made in view of these circumstances, and an object thereof is to provide a magnetoresistive element of a spin-transfer-torque writing type that requires only a low current to cause a magnetization reversal in a magnetization free layer having a high magnetization reversal energy required for retaining information, and also provide a magnetoresistive random access memory including the magnetoresistive element.

A magnetoresistive element according to a first aspect of the present invention includes: a first magnetization reference layer having magnetization perpendicular to a film plane, a direction of the magnetization being invariable and in one direction; a magnetization free layer having magnetization perpendicular to the film plane, a direction of the magnetization being variable; a first intermediate layer provided between the first magnetization reference layer and the magnetization free layer; a magnetic phase transition layer provided on an opposite side of the magnetization free layer from the first intermediate layer, the magnetic phase transition layer being magnetically coupled to the magnetization free layer, and being capable of bidirectionally performing a magnetic phase transition between an antiferromagnetic material and a ferromagnetic material; and an excitation layer provided on an opposite side of the magnetic phase transition layer from the magnetization free layer, and causing the magnetic phase transition layer to perform the magnetic phase transition from the antiferromagnetic material to the ferromagnetic material, the magnetization direction of the magnetization free layer being variable by flowing a current between the first magnetization reference layer and the magnetization free layer via the first intermediate layer.

A magnetoresistive element according to a second aspect of the present invention includes: a first magnetization reference layer having magnetization perpendicular to a film plane, a direction of the magnetization being invariable and in one direction; a magnetization free layer having magnetization perpendicular to the film plane, a direction of the magnetization being variable; a first intermediate layer provided between the first magnetization reference layer and the magnetization free layer; a magnetic phase transition layer provided on an opposite side of the magnetization free layer from the first intermediate layer, the magnetic phase transition layer being magnetically coupled to the magnetization free layer, and being capable of bidirectionally performing a magnetic phase transition between an antiferromagnetic material and a ferromagnetic material; a second magnetization reference layer provided on an opposite side of the magnetic phase transition layer from the magnetization free layer, the second magnetization reference layer having magnetization perpendicular to the film plane, a direction of the magnetization being invariable and in one direction and being antiparallel to the magnetization direction of the first magnetization reference layer; a second intermediate layer provided between the magnetic phase transition layer and the second magnetization reference layer, and causing the magnetic phase transition layer to perform the magnetic phase transition from the antiferromagnetic material to the ferromagnetic material, the magnetization direction of the magnetization free layer being variable by flowing a current between the first magnetization reference layer and the magnetization free layer via the first intermediate layer.

A magnetoresistive random access memory according to a third aspect of the present invention includes: the magnetoresistive element according to any one of the first and second aspects as a memory cell.

A magnetoresistive random access memory according to a fourth aspect of the present invention includes: a memory cell including the magnetoresistive element according to claim 1 and a transistor having one end series-connected to one end of the magnetoresistive element; a first write current circuit connected to the other end of the magnetoresistive element; and a second write current circuit connected to the other end of the transistor, and, in cooperation with the first write current circuit, flowing the current between the first magnetization reference layer and the second magnetization reference layer via the second intermediate layer.

### BRIEF DESCRIPTION OF THE DRAWINGS

FIG. 1 is a cross-sectional view of a magnetoresistive element in accordance with a first embodiment;

FIG. 2 is a cross-sectional view of a magnetoresistive element in accordance with a second embodiment;

FIG. 3 is a cross-sectional view for explaining the magnetization state of the magnetoresistive element of each embodiment at the time of storing and reading information;

FIGS. 4(a) to 4(e) illustrate a magnetization reversal caused at the time of writing in the magnetoresistive element of each embodiment;

FIG. 5 is a cross-sectional view of a magnetoresistive element in accordance with a modification of the first embodiment;

FIG. 6 is a cross-sectional view of a memory cell in a MRAM in accordance with a third embodiment; and

FIG. 7 is a circuit diagram for showing the principle components of the MRAM of the third embodiment.

### DESCRIPTION OF THE EMBODIMENTS

The following is a description of embodiments of the present invention, with reference to the accompanying drawings. In the following description, like components having like functions and structures are denoted by like reference numerals, and explanation is repeated only where necessary.

### First Embodiment

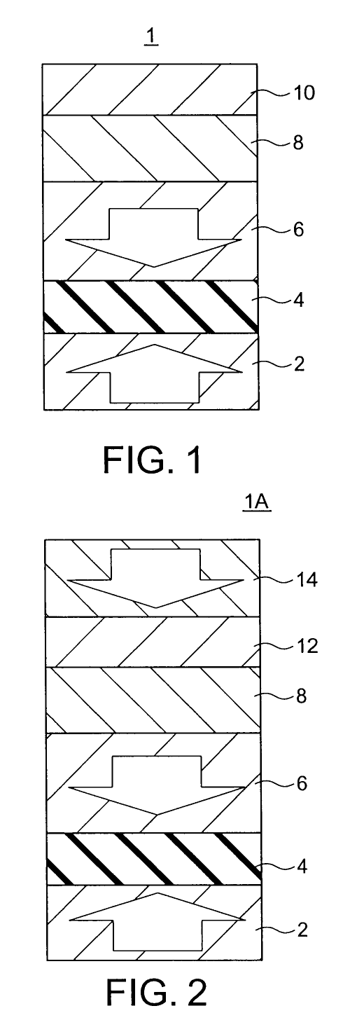

FIG. 1 shows a magnetoresistive element (MR element) in accordance with a first embodiment of the present invention. FIG. 1 illustrates the stacked structure as the principal body of the MR element of this embodiment. In FIG. 1, the arrows indicate magnetization directions.

The MR element is designed to be in one of two steady states in accordance with the direction of the bidirectional current flowing in a direction perpendicular to the film plane. The two steady states are associated with “0” date and “1” data, respectively, so that the MR element can store binary data. This is called the spin-transfer-torque writing method, by which the magnetization is varied with the direction of the current flowing direction and information corresponding to the magnetization state is stored.

The MR element 1 of this embodiment includes: a magnetization reference layer (hereinafter also referred to as a reference layer) 2 that is made of a ferromagnetic material or a ferrimagnetic material, has magnetization substantially perpendicular to the film plane (hereinafter also referred to as perpendicular magnetization), and has a magnetization of which a direction is invariable in one direction; a magnetization free layer (hereinafter also referred to as a free layer) 6 that is made of a ferromagnetic material or a ferrimagnetic material, has magnetization substantially perpendicular to the film plane, and has a magnetization of which a direction is variable; an intermediate layer 4 that is provided between the magnetization reference layer 2 and the magnetization free layer 6; a magnetic phase transition layer 8 that is formed in contact with the face of the magnetization free layer 6 on the opposite side from the intermediate layer 4, is magnetically connected to the magnetization free layer 6, and has a magnetic phase transition between an antiferromagnetic material and a ferromagnetic material; and an excitation layer 10 that is formed in contact with the face of the magnetic phase transition layer 8 on the opposite side from the magnetization free layer 6, and is designed to control the phase transition of the magnetic phase transition layer 8. It is also possible to form interfacial magnetic layers at the interface between the magnetization free layer 6 and the intermediate layer 4, and at the interface between the magnetization reference layer 2 and the intermediate layer 4. Those interfacial magnetic layers are not shown in FIG. 1, being contained in the magnetization free layer 6 or the magnetization reference layer 2.

### Second Embodiment

FIG. 2 shows a magnetoresistive element (MR element) in accordance with a second embodiment of the present invention. FIG. 2 illustrates the stacked structure as the principal body of the MR element of this embodiment. In FIG. 2, the arrows indicate magnetization directions.

The MR element 1A of the second embodiment includes: a magnetization reference layer 2 that is made of a ferromagnetic material or a ferrimagnetic material, has perpendicular magnetization, and has a magnetization of which a direction is invariable in one direction; a magnetization free layer 6 that is made of a ferromagnetic material or a ferrimagnetic material, has perpendicular magnetization, and has a magnetization of which a direction is variable; an intermediate layer 4 that is provided between the magnetization reference layer 2 and the magnetization free layer 6; a magnetic phase transition layer 8 that is formed in contact with the face of the magnetization free layer 6 on the opposite side from the intermediate layer 4, is magnetically coupled to the magnetization free layer 6, and has a magnetic phase transition between an antiferromagnetic material and a ferromagnetic material; a magnetization reference layer 14 that is formed on the opposite side of the magnetic phase transition layer 8 from the magnetization free layer 6, is made of a ferromagnetic material or a ferrimagnetic material, has perpendicular magnetization, and has a magnetization of which a direction is invariable in one direction; and an intermediate layer 12 that is provided between the magnetic phase transition layer 8 and the magnetization reference layer 14, and has the function to control the phase transition of the magnetic phase transition layer 8. It is also possible to form interfacial magnetic layers at the interface between the magnetization free layer 6 and the intermediate layer 4, at the interface between the magnetization reference layer 2 and the intermediate layer 4, and at the interface between the magnetization reference layer 14 and the intermediate layer 12. Those interfacial magnetic layers are not shown in FIG. 2, being contained in the magnetization free layer 6, the magnetization reference layer 2, and the magnetization reference layer 14.

In the MR element 1A of the second embodiment, the two magnetization reference layers 2 and 14 are provided so that the intermediate layers 4 and 12 are interposed between the magnetization free layer 6 and the magnetization reference layers 2 and 14, respectively. The structure of the MR element 1A is called a “dual structure”. The structure of the MR element of the first embodiment is called a “single structure”.

The materials of the respective layers in the MR elements of the first and second embodiments are mostly the same, and will be described later in detail.

Spin injection magnetization reversals in the MR elements of the first and second embodiments are based on the same principles.

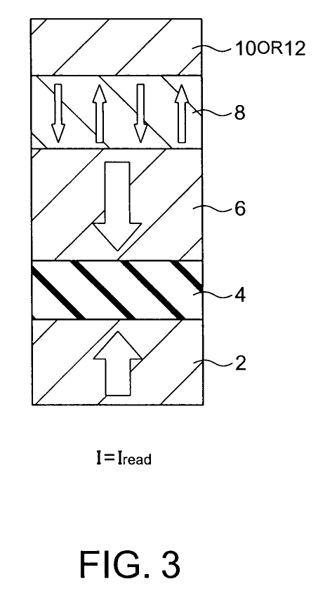

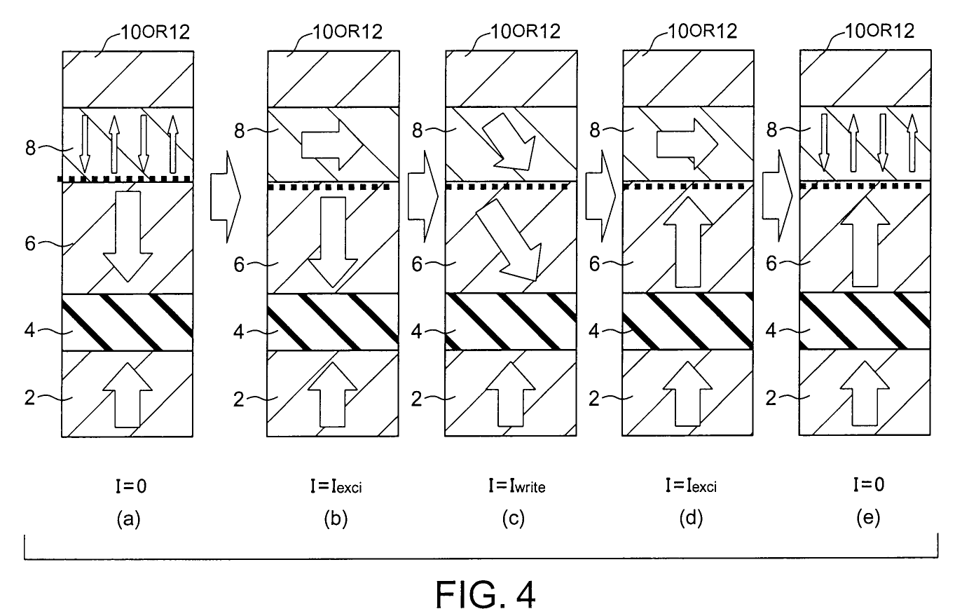

Referring now to FIG. 3 and FIGS. 4(a) to 4(e), the mechanism of a spin injection magnetization reversal in the MR elements of the first and second embodiments is described. FIG. 3 illustrates the magnetization state at the time of reading and information retaining. FIGS. 4(a) to 4(e) illustrate the magnetization state at the time of writing.

First, the relationship between the magnetization reversal current caused by spin injection and the parameters such as the energy amount required for a magnetization reversal is described.

Where the magnetization reversal current I_{c} caused by spin injection is generated by a spin momentum transfer based on the free electron model, the magnetization reversal current I_{c} is analytically expressed by the following expression (1):

I_{c}∝η×α×ΔE×k_{B}×T (1)

In this expression, ΔE represents the activation energy necessary for a magnetization reversal in the magnetization free layer 6 (hereinafter also referred to as the magnetization energy), η represents the spin injection efficiency, α represents the damping constant, k_{B} represents the Boltzmann constant, and T represents the effective temperature.

Because of the characteristics of the spin-injection MRAM device structure, an upper limit is set to the amount of current that can be applied. Therefore, when η and α as the material parameters and the effective temperature T are determined, the magnetization energy ΔE of the magnetization free layer that can have a magnetization reversal is determined. This magnetization energy ΔE is set as magnetization energy ΔEw.

According to the relationship expressed by the expression (1), the magnetization reversal current of the magnetization free layer 6 can be effectively reduced by reducing the magnetization energy ΔEw observed at the time of writing (hereinafter also referred to as the write magnetization energy). Meanwhile, the magnetization energy ΔE of the magnetization free layer 6 is the energy index indicating the stability of the magnetization of the magnetization free layer 6. In a memory operation of a spin-injection MRAM, the magnetization energy ΔEr necessary for retaining information (hereinafter also referred to as the information retaining magnetization energy) is defined, so as to compensate for the operation temperature. As the information retaining magnetization energy ΔEr becomes larger, it becomes more difficult for the magnetization free layer 6 to have a magnetization reversal, or the information retaining ability of the magnetization free layer 6 becomes higher. Therefore, the memory should be designed to satisfy the inequality: ΔEw≦ΔEr. In view of this, the magnetization energy of the magnetization free layer 6 having the high information retaining magnetization energy ΔEr needs to be reduced to the magnetization energy ΔEw that enables writing.

Next, the mechanism of a low-current magnetization reversal in a MR element of the first or second embodiment is described in detail.

In a MR element of the first or second embodiment, the magnetization energy of the magnetization free layer 6 having a sufficiently high information retaining magnetization energy can be reduced to a suitable write magnetization energy, and the magnetization free layer 6 can have magnetization reversals in a stable manner.

The principles in setting the magnetization energy ΔE of the magnetization free layer 6 are now described. As described above, the magnetization energy necessary for retaining information is set as ΔEr, and the magnetization energy that enables writing in the device structure is set as ΔEw. The designed values of the magnetization energy ΔE of the magnetization free layer 6 should be as follows:

At the time of retaining information:

ΔE≧ΔEr≧ΔEw (2)

At the time of writing:

ΔEr≧ΔEw≧ΔE (3)

In the MR element of the first or second embodiment, the magnetization free layer 6 has perpendicular magnetization. With a perpendicularly magnetized film, the above described variations of the magnetization energy ΔE can be realized by controlling the magnetic crystalline anisotropy Kᵤ as a material physical value and the saturation magnetization.

The magnetization energy ΔE of the magnetization free layer 6 is expressed as:

ΔE=Kₑ×Va/(k_{B}×T) (4)

where k_{B} represents the Boltzmann constant, T represents the effective temperature, Va represents the effective magnetization volume (or the activation volume) of the magnetization free layer 6, and Kₑ represents the effective magnetic anisotropy energy of the magnetization free layer 6.

In the case of perpendicular magnetization, the effective magnetic anisotropy energy Kₑ is expressed as:

Kₑ=K_{U}−2πMₛ² (5)

where Kᵤ represents the uniaxial magnetic anisotropy energy of the magnetization free layer 6 in the vertical direction, and Mₛ represents the saturation magnetization of the magnetization free layer 6. When Kₑ is larger than 0, perpendicular magnetization is observed. When Kₑ is smaller than 0, in-plane magnetization is observed. Accordingly, perpendicular magnetization can be reversed to in-plane magnetization by controlling Kₑ to change from a value larger than 0 to a value smaller than 0.

The first and second embodiments of the present invention take advantage of the physical phenomenon in which the magnetic phase transition layer 8 in contact with the magnetization free layer 6 having perpendicular magnetization goes through a magnetic phase transition from an antiferromagnetic material to a ferromagnetic material. As will be described later in detail, the material of the magnetic phase transition layer 8 may be a FeRh alloy. When reaching a certain energy state (a phase transition temperature Tx, for example), the magnetic phase transition layer 8 goes through a magnetic phase transition from an antiferromagnetic material to a ferromagnetic material. The layer to cause activation to the phase transition energy (the layer to increase the temperature to the phase transition temperature, for example) is the excitation layer 10 or the intermediate layer 12. The excitation layer 10 and the intermediate layer 12 apply a current so as to provide the energy necessary for the magnetic phase transition layer 8 to perform a phase transition (or to increase the temperature to the phase transition temperature, for example).

The magnetic phase transition layer 8 is magnetically coupled to the magnetization free layer 6. Being exchange-coupled to the magnetization free layer 6, the magnetic phase transition layer 8 has a magnetization reversal in synchronization with the magnetization of the magnetization free layer 6. In other words, the magnetization free layer 6 and the magnetic phase transition layer 8 have magnetization reversals in synchronization with each other. By taking advantage of the above described effects, it is possible to control the magnetization energy in the perpendicular magnetization of the magnetization free layer 6, as the saturation magnetization of the magnetization free layer 6 varies, in appearance, with the magnetic transitions of the magnetic phase transition layer 8. In FIG. 4, the dotted line indicates the exchange coupling between the magnetization free layer 6 and the magnetic phase transition layer 8.

Although the magnetization free layer 6 has perpendicular magnetization in this embodiment, the magnetization free layer 6 originally has an information retaining magnetization energy that is large enough to hold information.

Next, magnetization reversals of the magnetization free layer of a MR element of the present invention having the magnetic phase transition layer 8 exchange-coupled to the magnetization free layer 6 having perpendicular magnetization are described. In the following, the magnetic crystalline anisotropy energy in a case where the magnetic phase transition layer 8 is in an antiferromagnetic state is represented by K_{u-AFM}, and the saturation magnetization and the magnetic crystalline anisotropy energy in a case where the magnetic phase transition layer 8 has gone through a phase transition to a ferromagnetic material are represented by M_{s-FM} and K_{u-FM}, respectively. Here, K_{u-FM}≈K_{u-AFM} and each of the magnetic crystalline anisotropy energies is sufficiently smaller than Kᵤ of the magnetization free layer 6 having perpendicular magnetization. Accordingly, the saturation magnetization and the magnetic crystalline anisotropy after a phase transition of the magnetic phase transition layer 8 are represented by M_{s-PT} and K_{u-PT}, respectively, and the values of M_{s-PT} and K_{u-PT} are values averaged with the volume ratio between the ferromagnetic portion and the antiferromagnetic portion in the magnetic phase transition layer 8. Accordingly, in the first and second embodiments, Kₑ of the magnetic phase transition layer 8 is smaller than 0 after the magnetic phase transition layer 8 goes through a phase transition to a ferromagnetic material, and the magnetic phase transition layer 8 has in-plane magnetization.

At the time of retaining or reading information (I=0 or I_{read}), the magnetic phase transition layer 8 shown in FIG. 3 is entirely or partially in an antiferromagnetic state. Therefore, the saturation magnetization is almost 0 (M_{s-PT}≈0), and has little influence on the magnetization energy ΔE of the magnetization free layer 6 having perpendicular magnetization.

Meanwhile, at the time of energization for writing, the energy necessary for the magnetic phase transition layer 8 to perform a phase transition is supplied from the excitation layer 10 or 12 during the process of applying a current (I=I_{exci}) to the MR element 1 or 1A, so that the magnetic phase transition layer 8 entirely or partially perform a magnetic phase transition from an antiferromagnetic material to a ferromagnetic material. In other words, the magnetization of the magnetic phase transition layer 8 changes from perpendicular magnetization to in-plane magnetization (FIG. 4(a) and FIG. 4(b)). At this point, the magnetic phase transition layer 8 has the saturation magnetization M_{s-PT}. Accordingly, the magnetization energy state of the magnetization free layer 6 having perpendicular magnetization varies since the information retaining time (I=0) shown in FIG. 4(a), and the magnetization energy of the magnetization free layer 6 decreases when I is I_{exci} (FIG. 4(b)). Thus, the effective anisotropy energy K_{e-w} is expressed as:

K_{e-w}=(t_{Free}×K_{U}+t_{PT}×K_{U-PT})/(t_{Free}+t_{PT})−2π[(t_{Free}_{ₑ}×Mₛ+t_{PT}×M_{S-PT})/(t_{Free}+t_{PT})]² (6)

Since Kᵤ is much larger than K_{u-PT} in the above equation, the effective anisotropy energy K_{e-w} is approximately expressed as:

K_{e-w}≈t_{Free}×K_{U}/(t_{Free}+t_{PT})−2π[(t_{Free}_{ₑ}×Mₛ+t_{PT}×M_{S-PT})/(t_{Free}+t_{PT})]² (7)

where t_{Free} represents the film thickness of the magnetization free layer 6 having perpendicular magnetization, and t_{PT} represents the film thickness of the magnetic phase transition layer 8.

Meanwhile, the relationship between the excitation current I_{exci} and the write current I_{write} is expressed as: I_{exci}≦I_{write}. Accordingly, when the write current (I=I_{write}) is applied, the energy for a magnetic phase transition has already been generated, and the effective anisotropy energy K_{e-w} is smaller than the anisotropy energy Kₑ₋ᵣ observed at the time of information retaining. Therefore, at the time of writing shown in FIG. 4(c), the magnetization energy ΔE of the magnetization free layer 6 becomes smaller, and the following inequality is established:

ΔEr≧ΔEw≧ΔE (8)

where ΔE is equal to K_{e-w}×Va/(k_{B}×T).

To sum up, by applying the current (I=I_{write}) to the magnetization free layer 6 having perpendicular magnetization with high information retaining properties, it is possible to cause a spin-injection magnetization reversal (FIGS. 4(c), 4(d), and 4(e)).

If the magnetization energy ΔE of the magnetization free layer 6 becomes too small at the time of write current application, the problem of stochastic write errors is caused due to the influence of thermal disturbance.

The magnetization energy ΔEw of the magnetization free layer 6 at the time of writing needs to be set by an error compensating circuit, so that the stochastic write errors that might be caused at the time of reading (read disturbance) can be compensated for. This is because a magnetization reversal might be caused stochastically by the current applied at the time of reading, as the magnetization energy of the magnetization free layer 6 has a normal distribution. The relationship between the mean current at the time of reading and the mean current at the time of writing is determined by the capacity of the designed memory and the variation of the write current.

Next, the effects and characteristics of the MR element 1A of the second embodiment are described.

In this MR element 1A, the intermediate layer (the second intermediate layer) 12 is formed in contact with the magnetic phase transition layer 8 on the opposite side from the magnetization free layer 6, and the magnetization reference layer (the second reference layer) 14 is formed, so as to form a so-called dual structure. Accordingly, the magnetization directions of the magnetization reference layer (the first reference layer) 2 and the magnetization reference layer (the second reference layer) 14 are antiparallel to each other.

In a MR element of a conventional spin injection type, the dual structure is formed with a second reference layer, a second intermediate layer, a free layer, a first intermediate layer, and a first reference layer. The magnetization directions of the first reference layer and the second reference layer are antiparallel to each other. In this case, there is a difference in resistance between the unit formed with the second reference layer, the second intermediate layer, and the free layer (hereinafter referred to as the upper unit), and the unit formed with the free layer, the first intermediate layer, and the first reference layer (hereinafter referred to the lower unit). This difference in resistance cancels the magnetoresistive effect (MR) of each unit. Since the write current depends on the MR, it is necessary to maintain a high MR ratio between the upper unit and the lower unit, so as to reduce the write current in the dual structure. However, the MR at the time of reading in that case is merely the difference between the upper unit and the lower unit, and the MR ratio becomes dramatically lower.

In the MR element 1A of the second embodiment, on the other hand, MR is observed at the time of reading and writing in the unit formed with the free layer 6, the first intermediate layer 4, and the first reference layer 2 having perpendicular magnetization, since the unit includes a ferromagnetic material, an intermediate layer, and a ferromagnetic material. In the unit formed with the second reference layer 14, the second intermediate layer 12, and the magnetic phase transition layer 8, MR is not observed at the time of reading, since the unit includes a ferromagnetic material, an intermediate layer, and an antiferromagnetic material that is the magnetic phase transition layer 8. As a result, a spin torque is not applied to the free layer 6 at the time of reading. At the time of writing, however, a phase transition to a ferromagnetic material is caused in the magnetic phase transition layer 8, and a MR ratio is observed, since the unit includes a ferromagnetic material, an intermediate layer, and a ferromagnetic material. Accordingly, an effective spin torque is applied to the free layer 6 only at the time of writing.

In the MR element 1A of the second embodiment, a spin torque is doubly applied to the free layer 6 only at the time of writing. At the time of reading, MR is not observed in the unit formed with the second reference layer 14, the second intermediate layer 12, and the magnetic phase transition layer 8. Therefore, a high MR can be maintained in the unit formed with the free layer 6, the first intermediate layer 4, and the first reference layer 2 having perpendicular magnetization. However, the MR ratio becomes lower by the amount equivalent to the resistance in the second intermediate layer 12.

Next, specific materials for the respective layers in the MR elements of the first and second embodiments are described in detail.

### Magnetic Phase Transition Layer

The magnetic phase transition layer 8 needs to be made of a material that is capable of causing a bidirectionally magnetic phase transition between a ferromagnetic state and an antiferromagnetic state. A FeRh alloy is employed for the magnetic phase transition layer 8. A FeRh alloy has a body-centered cubic (BCC) structure, and forms a Fe₅₀Rh₅₀ ordered phase having a CsCl structure within a composition range expressed as Fe₁₋ₓRhₓ (0.3≦x≦0.7), which shows the relative proportions of Fe and Rh. Almost the entire film becomes an ordered phase in the neighborhood of the relative proportions of Fe₅₀Rh₅₀ (at %). When the temperature becomes higher than a predetermined phase transition temperature T₀, a BCC-FeRh alloy goes through a magnetic phase transition from an antiferromagnetic material to a ferromagnetic material. This is called the first-order phase transition. The first-order phase transition temperature T₀ is approximately 400 K in a case of a thin film. The first-order phase transition temperature T₀ can be increased or decreased by adding an element A (at least one element selected from the group consisting of V, Cr, Mn, Fe, Co, Ni, Cu, Ru, Pd, Ag, Os, Ir, Pt, and Au) to the BCC-FeRh alloy by replacing the Rh with the element A. More specifically, the first-order phase transition temperature T₀ becomes lower when part of the Rh is replaced with a 3d element A^{3d} (at least one element selected from the group consisting of V, Cr, Mn, Fe, Co, Ni, and Cu), and first-order phase transition temperature T₀ becomes higher when part of the Rh is replaced with a 5d element A^{5d} (at least one element selected from the group consisting of Ir, Os, Pt, Au, Pd, Ru, and Ag). The first-order phase transition temperature T₀ can be adjusted in the range of 100° C. to 300° C. by controlling the additive amount of the element A.

The saturation magnetization of the BCC-FeRh in a ferromagnetic state is approximately 800 emu/cc to 1300 emu/cc, and the magnetic crystalline anisotropy is equal to or less than 1×10⁶ erg/cc.

To restrain an increase in saturation magnetization when the magnetic phase transition layer 8 goes through a phase transition to a ferromagnetic state, it is preferable to use V, Cr, Mn, or Cu among the elements A^{3d}, and it is more preferable to use the element A^{5d}.

Also, it is preferable that the additive amount of the element A is adjusted so as not to lose the CsCl structure of the FeRh alloy. More specifically, the additive amount should preferably be within the range expressed as Fe₁₋ₓ(Rh_{1-y}A_{y})ₓ (0.3≦x≦0.7, 0<y<1), which shows the relative proportions of Fe and Rh. If x becomes smaller than 0.3 or larger than 0.7, the (100) superlattice peak induced by the CsCl ordered structure disappears, and the CsCl ordered structure phase that causes a magnetic phase transition is lost. The CsCl ordered structure in the BCC-FeRh alloy can be observed, as the (100) peak that does not appear in a BCC structure by the extinction rule is seen by regulating. The above structure can be observed in a θ−2θ diffraction image by an X-ray diffractometer. The (100) peak appears in the neighborhood of 30 degrees to 40 degrees at 2θ. The (100) peak can also be observed through an electron diffraction pattern by a transmission electron microscopy or through diffraction patterns (such as ring and spot patterns) by a reflection electron diffractometer.

### Magnetization Free Layer Having Perpendicular Magnetization

The magnetization free layer 6 is made of a material having perpendicular magnetization characteristics. Here, “perpendicular magnetization” and “magnetization substantially perpendicular to the film plane” is defined as the state in which the ratio (Mr/Ms) between the residual magnetization Mr and the saturation magnetization Ms when there is not a magnetic field is 0.5 or higher in the magnetization-field (M-H) curve obtained by measuring VSM (vibration sample magnetization). The film thickness of the magnetization free layer 6 should preferably be in the range of 0.5 nm to 5 nm, so as to achieve effective spin-torque transmission. If the film thickness is smaller than 0.5 nm, controllability as a continuous film cannot be obtained. If the film thickness is larger than 5 nm, it greatly exceeds the characteristic length with which a spin torque can be validly applied, and a magnetization reversal cannot be caused by spin injection in the magnetization free layer 6. The characteristic length with which a spin torque is validly applied is approximately 1.0 nm, which is the distance at which spin precession goes through a cycle when spins move in a drifting manner. Whether a magnetization reversal is caused by a spin torque in the magnetization free layer 6 is determined by the magnetization reversal energy of the magnetization free layer 6.

Examples of the materials that exhibit perpendicular magnetization include a CoPt alloy having a hexagonal closed pack (HCP) structure or a face-centered cubic (FCC) structure, a CoCrPt alloy, and a CoCrPtTa alloy. To exhibit magnetization perpendicular to the film plane, the material needs to be orientated toward the (001) plane in a HCP structure, and needs to be orientated toward the (111) plane in a FCC structure. A phase transition layer having a CsCl ordered structure phase tends to be orientated toward the (110) plane.

The examples of the materials that exhibit perpendicular magnetization also include a RE-TM alloy that is formed with a rare earth metal (hereinafter also referred to as RE) and an element selected from the group consisting of Co, Fe, and Ni (hereinafter also referred to as the TM element), and has an amorphous structure. The net saturation magnetization of the RE-TM alloy can be controlled to have a positive value from a negative value by adjusting the amount of the RE element. The point where the net saturation magnetization Ms-net becomes zero is called the compensation point, and the composition observed at this point is called the compensation point composition. In the compensation point composition, the proportion of the RE element falls in the range of 25 at % to 50 at %.

The examples of the materials that exhibit perpendicular magnetization also include an artificial-lattice perpendicular magnetization film formed with multilayer stacked layers: a magnetic layer containing an element selected from the group consisting of Co, Fe, and Ni; and a nonmagnetic metal layer containing Pd, Pt, Au, Rh, Ir, Os, Ru, Ag, and Cu. The material of the magnetic layer may be a Co_{100-x-y}FeₓNi_{y} alloy film (0≦x≦100, 0≦y≦100). It is also possible to employ a CoFeNiB amorphous alloy having B added to the above CoFeNi alloy at 10 at % to 25 at %. The optimum film thickness of the magnetic layer is 0.1 nm to 1 nm. The optimum thickness of the nonmagnetic layer is 0.1 nm to 3 nm. The crystalline structure of the artificial lattice film may be a HCP structure, a FCC structure, or a BCC structure. In the case of a FCC structure, the artificial lattice film is partially orientated to the (111) plane. In the case of a BCC structure, the artificial lattice film is partially orientated to the (110) plane. In the case of a HCP structure, the artificial lattice film is partially orientated to the (001) plane. The orientation can be observed through X-ray diffraction or electron beam diffraction.

The examples of the materials that exhibit perpendicular magnetization also include a FCT structure ferromagnetic alloy that has a L1₀ ordered structure and is formed with at least one element selected from the group consisting of Fe and Co (hereinafter referred to the element A), and at least one element selected from the group of Pt and Pd (hereinafter referred to as the element B). Typical examples of L1₀ ordered structure ferromagnetic alloys include a L1₀-FePt alloy, L1₀-FePd alloy, and a L1₀-CoPt alloy. It is also possible to employ a L1₀-FeCoPtPd alloy that is an alloy of the above elements. To form such a L1₀ ordered structure, x needs to be in the range of 30 at % to 70 at %, where the relative proportions of the element A and the element B are expressed as A₁₀₀₋ₓBₓ. Part of the element A can be replaced with Ni or Cu. Part of the element B can be replaced with Au, Ag, Ru, Rh, Ir, Os, or a rare earth metal (such as Nd, Sm, Gd, or Tb). Accordingly, the saturation magnetization Ms and the magnetic crystalline anisotropy energy (uniaxial magnetic anisotropy energy) Kᵤ of the magnetization free layer 6 having perpendicular magnetization can be adjusted and optimized.

The above described ferromagnetic AB alloy having a L1₀ ordered structure is a face-centered tetragonal (FCC) structure. By regulating the structure, a large magnetic crystalline anisotropy energy of approximately 1×10₇ erg/cc can be obtained in the [001] direction. In other words, excellent perpendicular magnetization characteristics can be achieved through preferential orientation toward the (001) plane. The saturation magnetization is approximately in the range of 600 emu/cm³ to 1200 emu/cm³. In a case where an element is added to the alloy by replacing a component with the element A or the element B, the saturation magnetization and the magnetic crystalline anisotropy energy become smaller. On the (001) plane of the ferromagnetic AB alloy having the above described L1₀ ordered structure, a BCC structure alloy containing Fe, Cr, V, or the like as a principal component easily grows, preferentially orientated to the (001) plane.

On the (001) plane of a L1₀-AB alloy, the above described CsCl-structure FeRh alloy grows, preferentially orientated to the (001) plane.

The preferential orientation of a FCT-FePt alloy to the (001) plane can be observed as a (002) peak in the neighborhood of the point where 2θ is 45 to 50 degrees by performing a θ−2θ scan with X-ray diffractometer. To improve the perpendicular magnetization characteristics, the half width of the rocking curve of the (002) diffraction peak needs to be 10 degrees or less, and, more preferably, 5 degrees or less.

The existence of a L1₀ ordered structure phase and the preferential orientation to the (001) plane can be observed as a (001) peak in the neighborhood of the point where 2θ is 20 to 25 degrees by performing a θ−2θ scan with X-ray diffractomter.

Those diffraction images on the (001) plane and the (002) plane can be observed through electron beam diffraction or the like.

### Magnetization Reference Layer Having Perpendicular Magnetization

The materials that can be used for the magnetization reference layer 2 and the magnetization reference layer 14 in the first and second embodiments of the present invention are almost the same as the above described materials that can be used for the magnetization free layer 6.

However, each magnetization reference layer needs to have a magnetization of which a direction is reference in one direction, and its film thickness should be controlled so as not to cause a magnetization reversal when a current is applied. In practice, the magnetic crystalline anisotropy of each magnetization reference layer should preferably be larger than the magnetic crystalline anisotropy of the magnetization free layer. Furthermore, the film thickness of each magnetization reference layer should preferably be larger than the film thickness of the magnetization free layer, and, in practice, should preferably be twice the film thickness of the magnetization free layer.

To achieve the MR ration necessary for reading, it is preferable that an interfacial magnetic layer is inserted at the interface between the magnetization reference layer 2 and the intermediate layer 4. The interfacial magnetic layer may be made of a single metal or an alloy containing at least one element selected from the group consisting of Co, Fe, and Ni. In a case where an intermediate layer 4 having a NaCl structure preferentially-orientated to the (001) plane, an interfacial magnetic layer having a BCC structure preferentially-orientated to the (001) plane is preferred. Alternatively, it is possible to employ an interfacial magnetic layer having an amorphous structure having B, C, P, N, or the like added thereto. The film thickness of the interfacial magnetic layer should be 0.5 nm or larger to increase the MR ratio. However, the film thickness of the interfacial magnetic layer should preferably be 4 nm or smaller. If the film thickness of the interfacial magnetic layer is larger than 4 nm, the perpendicular magnetization characteristics of the magnetization reference layer are degraded. In this case, the saturation magnetization of the interfacial magnetic layer is in the range of 0.5 T (tesla) to 2.4 T, which can be adjusted by controlling the relative proportions of the elements in the interfacial magnetic layer.

Another interfacial magnetic layer may be provided between the magnetization free layer 6 and the intermediate layer 4.

### Excitation Layer

In the first embodiment, a phase transition of the magnetic phase transition layer 8 is caused by injecting energy mainly from the excitation layer 10. The magnetic phase transition layer 8 is energy-excited by the heat generated from the excitation layer 10 or the injection of high-energy electrons (such as hot electrons) injected over excitation layer 10. In this manner, the magnetic phase transition layer 8 is activated and goes through a magnetic phase transition. When generating heat, the excitation layer 10 utilizes the Joule heat generated at the time of energization. The Joule heat generated through energization is determined by the specific resistance, the specific heat, the density, and the energizing time of the excitation layer 10 as the heat source. Therefore, the film thickness of the excitation layer and the size of the MR element are also important factors. The MR element size should be 10 nm or larger, in view of the device process design. To generate heat at 100° C. or higher in a spin-injection MRAM device, the specific resistance of the excitation layer needs to be 100 μΩcm or higher, with the heat generation from the Joule heat being taken into consideration. In a MR element used in an actual spin-injection MRAM, the heat generation temperature is controlled by adjusting the film thickness of the excitation layer 10. In a case where the specific resistance of the excitation layer is 200 μΩcm, the film thickness of the excitation layer needs to be 50 nm or larger. To reduce the MR element size in view of the device design, a thinner excitation layer is preferred, and higher specific resistance of the excitation layer is preferred accordingly. To sum up, to restrict the film thickness of the excitation layer to 50 nm or less, the specific resistance of the excitation layer should preferably be 200 μΩcm or higher. Also, the heat generation amount depends on the MR element size, or the energization cross-sectional area with respect to the excitation layer. With a smaller energization area, higher current density can be achieved, and heat is easily generated. The MR element size should preferably be 100 nm or less in the length in the short-side direction, in view of the device design.

In the above described case, the material of the excitation layer 10 may be a metal having an amorphous structure, a semiconductor, an insulating material, or the like. An amorphous metal layer may be made of amorphous Ta. Other than Ta, it is possible to employ an amorphous alloy of a high melting point element such as W, Ti, Mo, or Nb. To turn a metal layer amorphous, it is preferable to add a semiconductor element such as Si, Ge, or Ga, or add a half-metal element such as C, B, P, or S.

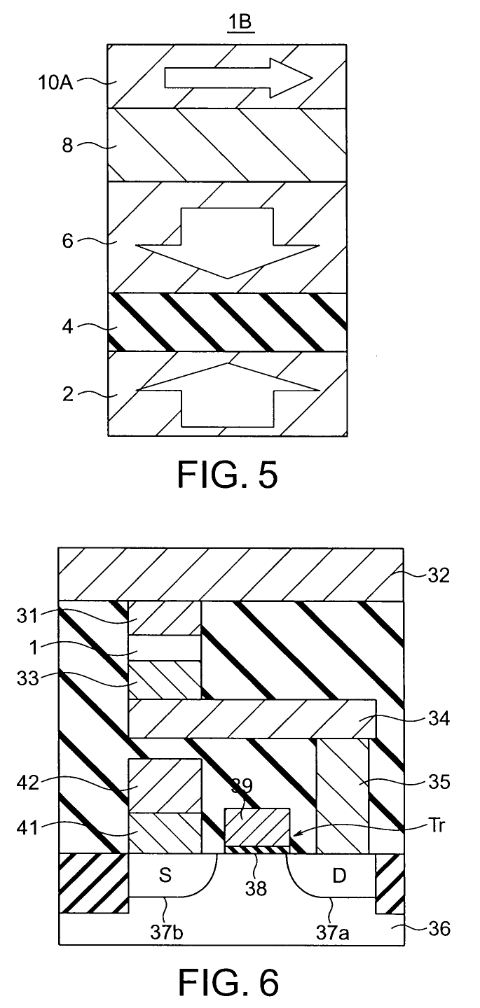

The excitation layer may be an amorphous CoFeB layer containing 3d ferromagnetic metals such as Co, Fe, and Ni. FIG. 5 shows a MR element 1B that is a modification of the first embodiment. This MR element 1B has an excitation layer 10A containing the above materials. In the MR element 1B of this modification, the excitation layer 10A needs to be an in-plane magnetization film. The excitation layer 10A is exchange-coupled to the magnetic phase transition layer 8. The magnetization state observed at the time of no energization is shown in FIG. 5. Being an antiferromagnetic material at the time of no energization, the excitation layer 10A can be exchange-coupled to ferromagnetic materials having difference magnetization directions below and above the excitation layer 10A, without a change in the magnetization arrangement. When energization is performed for writing, the excitation layer 10A has in-plane magnetization and is exchange-coupled to the magnetic phase transition layer 8, and the magnetic phase transition layer 8 becomes a ferromagnetic material. Accordingly, the excitation layer 10A as a ferromagnetic material plays a role of an assistant to the magnetic phase transition layer 8.

In a case where the excitation layer functions as a high-energy electron injection source, the excitation layer is preferably made of an insulating material or a semiconductor. Since insulating materials and semiconductors have high specific resistance, an excitation layer having a small thickness can be formed with an insulating material or a semiconductor. In practice, the film thickness of the excitation layer is reduced to 2 nm or less. In the case where the excitation layer is made of an insulating material or a semiconductor, high-energy electrons are injected into the magnetic phase transition layer 8, and the energy released to the lattice system is converted to thermal energy and is dispersed. In such a case, it is considered that the magnetic phase transition layer 8 generates heat immediately after the high-energy electron injection. If the resistance at the interface between the excitation layer and the magnetic phase transition layer (the interfacial resistance) is high, most energy of the injected electrons is lost at the interface, and heat is generated from the interface.

Specific examples of materials that can be used for the excitation layer include oxides each having a NaCl structure, such as MgO, CaO, SrO, BaO, TiO, EuO, VO, CrO, CoO, FeO, and CdO. It is also possible to employ NbO or the like having a NbO structure that is similar to a NaCl structure. Some of those oxides may be combined. Each of those oxide materials easily has preferential orientation toward the (001) plane, and exhibits excellent lattice consistency with the (001) plane of the magnetization free layer and the magnetization reference layer having the above described BCC structure or FCT structure. Accordingly, each of those oxide materials easily has preferential orientation to the (001) plane on a BCC metal or a FCT metal. Further, on the excitation layer having a NaCl structure preferentially-orientated to the (001) plane, the magnetization free layer and the magnetization reference layer having a BCC structure or a FCT structure easily have preferential orientation to the (001) plane, and excellent perpendicular magnetization characteristics can be achieved.

The specific examples of materials that can be used for the excitation layer include amorphous oxides such as SiO₂ and Al₂O₃, semiconductors such as Si, Ge, and ZnSe, and oxide semiconductors such as TiO₂. Those materials have excellent interfacial lattice consistency with the magnetization free layer and the magnetization reference layer having the above described FCC structure or HCP structure, and contribute to excellent perpendicular magnetization characteristics of the magnetization free layer and the magnetization reference layer.

In a case where one of those excitation layer materials is employed, the size of the energy of the electrons is estimated from the Fermi level determined by the first-principle calculation and the energy gap with respect to the conduction level. The size of the electron energy is also controlled by adjusting the physical film thickness of the actual excitation layer. The film thickness of the excitation layer should be in the range of 0.1 nm to 2 nm. If the film thickness is less than 0.1 nm, it is difficult to control the film formation. If the film thickness exceeds 2 nm, the resistance of the MR element immediately becomes too high, and reading and writing with a predetermined voltage cannot be performed.

### Intermediate Layer 4

The intermediate layer 4 needs to function as an intermediate layer that induces the MR ratio of the MR element. In cases where the MR elements 1, 1A, and 1B are used as the memory elements of MRAMs, the resistance of the MR generating portions of the MR elements needs to be high enough to cancel the existing resistance of the wiring portions and the selective transistors. Therefore, TMR elements are often used in the MR elements used for MRAMs. In each TMR element, a tunnel barrier layer is used as the intermediate layer 4.

The tunnel barrier layer may be made of an oxide having a NaCl structure such as MgO, CaO, SrO, BaO, or TiO, an oxide such as Al₂O₃, or an oxide-based semiconductor such as TiO₂. To achieve a high TMR ratio, the existence of a polarized conduction band (Δl band) is necessary. In view of this, it is preferable that the tunnel barrier layer is made of MgO, CaO, SrO, BaO, or TiO having a NaCl structure. The tunnel barrier layer 4 made of one of those materials is preferentially orientated to the (001) plane, and the misfit at the interface between the magnetization free layer 6 and the magnetization reference layer 2 is reduced. In this manner, the conduction in the Δ1 band is caused. Therefore, the magnetization reference layer and the magnetization free layer in contact with the (001)-orientated tunnel barrier layer having the NaCl structure need to have BCC structures, FCT structures, or FCC structures, and the (001) plane of each structure and the (001) plane of the tunnel barrier layer need to form matched interfaces.

Particularly, MgO has a band structure with a spin filtering effect, and can achieve a high TMR ratio accordingly. Also, a MgO film orientated to the (001) plane can be relatively easily formed, and high spin injection efficiency can be achieved with the MgO film.

### Intermediate Layer 12

Since high spin injection efficiency is required at the time of writing, the intermediate layer 12 provided in the MR element of the second embodiment should preferably be the same as the intermediate layer 4.

At the same time, the intermediate layer 12 needs to have the functions of an excitation layer to induce a phase transition of the magnetic phase transition layer 8. As a function of an excitation layer, the function of generating heat or injecting high-energy electrons is needed in the intermediate layer 12. Therefore, the intermediate layer 12 is made of an insulating material that can also be used in the intermediate layer 4. It is also possible to employ a semiconductor, a ferromagnetic semiconductor, a ferromagnetic insulating material, or the like. In a case where a ferromagnetic semiconductor or a ferromagnetic insulating material is employed, the magnetization reference layer 14 can be omitted. In such a case, the intermediate layer 12 also serves as the magnetization reference layer 14.

The semiconductor used as the intermediate layer 12 may be TiO₂, GaAs, amorphous Ge, amorphous Si, or the like.

The ferromagnetic insulating material may be a ferrite material such as Fe₃O₄, which has a spin filtering effect and is also a half metal material.

The ferromagnetic semiconductor may be MnAlAs, for example.

Next, examples of MR elements of the first and second embodiments are described.

### EXAMPLE 1

First, a specific example of a MR element of the first embodiment is described.

The MR element includes a stacked structure having a cap layer/an excitation layer 10 formed with MgO (0.7 nm)/a magnetic phase transition layer 8 formed with Fe₅₀Rh₅₀ (10 nm)/a magnetization free layer 6 formed with Fe₅₀Pt₅₀ (2 nm) and Fe (0.5 nm)/an intermediate layer (barrier layer) 4 made of MgO (1 nm)/a magnetization reference layer 2 formed with Co₄₀Fe₄₀B₂₀ (2 nm) and Fe₅₀Pt₅₀ (10 nm)/a base layer.

The numeric values in the brackets indicate the layer thicknesses of the respective layers. Also, the magnetization reference layer 2 formed with Co₄₀Fe₄₀B₂₀ (2 nm) and Fe₅₀Pt₅₀ (10 nm) has a magnetization of which a direction is invariable in one direction. The Co₄₀Fe₄₀B₂₀ (2 nm) layer is an interfacial magnetic layer, and is inserted so as to increase the MR ratio. The Fe₅₀Pt₅₀ (10 nm) layer may have a magnetization of which a direction is invariable in one direction due to exchange coupling to an antiferromagnetic material. The film thickness ratio (t_{FeRh}/t_{FePt}) between the film thickness t_{FeRh} of the magnetic phase transition layer formed with Fe₅₀Rh₅₀ and the film thickness t_{FePt} of the Fe₅₀Pt₅₀ in the magnetization free layer is optimized within the range of 2 to 10.

### EXAMPLE 2

Next, a specific example of a MR element of the second embodiment is described.

The MR element includes a stacked structure having a cap layer/a magnetization reference layer 14 formed with Fe₅₀Pt₅₀ (10 nm) and Fe (1 nm)/an intermediate layer 12 made of MgO (0.7 nm)/a magnetic phase transition layer 8 formed with Fe₅₀Rh₅₀ (5 nm)/a magnetization free layer 6 formed with Fe₅₀Pt₅₀ (2 nm) and Fe (0.5 nm)/an intermediate layer (barrier layer) 4 made of MgO (1 nm)/a magnetization reference layer 2 formed with Co₄₀Fe₄₀B₂₀ (2 nm) and Fe₅₀Pt₅₀ (10 nm)/a base layer.

The numeric values in the brackets indicate the layer thicknesses of the respective layers. The Fe₅₀Pt₅₀ (10 nm) layers of the respective magnetization reference layers 2 and 14 are hard magnetic layers. The magnetization direction of the magnetization reference layers 2 and 14 is determined by the magnetization direction of the Fe₅₀Pt₅₀ (10 nm) layers. The Co₄₀Fe₄₀B₂₀ (2 nm) layer is an interfacial magnetic layer, and is inserted so as to increase the MR ratio.

In the first and second embodiments, a CoFeB layer is often inserted between the MgO layer 4 and the FePt layer in either of the magnetization free layer and the magnetization reference layer. However, it is also possible to insert a BCC-Fe layer or a BCC-FeCo alloy layer. Those layers are called an interfacial magnetization free layer and an interfacial magnetization reference layer, respectively, and are also referred to as interfacial magnetic layers. In a bottom pin structure formed with a magnetization free layer/an intermediate layer/a magnetization reference layer/a substrate, the above mentioned interfacial magnetization reference layer contributes to improvement in orientation of the intermediate layer made of MgO toward the (001) plane, and the interfacial magnetization free layer contributes to improvement in crystalline orientation of the magnetization free layer of a L1₀ ordered structure toward the (001) plane. In a top pin structure formed with a magnetization reference layer/an intermediate layer/a magnetization free layer/a substrate, the above mentioned interfacial magnetization free layer contributes to improvement in orientation of the MgO toward the (001) plane, and the interfacial magnetization reference layer contributes to improvement in crystalline orientation of the magnetization reference layer toward the (001) plane.

The interfacial magnetization free layer may be made of an alloy that is expressed as Fe_{1-x-y}CoₓNi_{y} (0≦x+y≦1, 0≦x, y≦1), which indicates the relative proportions of the components, or may be made of an amorphous FeCoNiB alloy formed by adding B to the former alloy at 15 at %≦B≦25 at %. The lattice mismatch with the barrier layer (the intermediate layer) made of MgO needs to be restricted to 5% or less, with epitaxial growth being taken into consideration. Therefore, it is preferable that the interfacial magnetic layers are FeCoNi alloy having BCC structures, or amorphous FeCoNiB alloy. In the first and second embodiments, recrystallization annealing is performed on each amorphous CeFeB layer used for increasing the MR ratio. Through this annealing, the amorphous FeCoNiB is recrystallized into a BCC structure. In this case, part of the B remains in the BCC-FeCoNi.

To minimize the lattice mismatch, the FeCoNi(B) alloy of the BCC structure that is grown on the (001) plane of the MgO has crystalline growth, while having the following relationships:
plane relationship: (001)_{MgO}//(001)_{BCC-FeCo(B)}
orientation relationship: [100]_{MgO}//[110]_{BCC-FeCO(B)}

The saturation magnetization MS^{FePt} of the Fe₅₀Pt₅₀ used in the embodiments is approximately 1000 emu/cm³, and the saturation magnetization MS^{FeRh} of the Fe₅₀Rh₅₀ in a ferromagnetic state is approximately 1100 emu/cm³. The magnetic crystalline anisotropy Ku^{FePt} of the Fe₅₀Pt₅₀ is approximately 1×10⁷ erg/cm³, and the magnetic crystalline anisotropy Ku^{FeRh} of the Fe₅₀Rh₅₀ in an antiferromagnetic state or a ferromagnetic state is equal to or less than 1×10⁶ erg/cm³.

### Third Embodiment

Next, a MRAM of a spin-transfer-torque writing type in accordance with a third embodiment of the present invention is described.

The MRAM of this embodiment includes memory cells. FIG. 6 is a cross-sectional view of one of the memory cells of the MRAM of this embodiment. As shown in FIG. 6, the upper face of an MR element 1 is connected to a bit line 32 via an upper electrode 31. The lower face of the MR element 1 is connected to a drain region 37a of the source and drain regions on the surface of a semiconductor substrate 36 via a lower electrode 33, an extension electrode 34, and a plug 35. The drain region 37a, a source region 37b, a gate insulating film 38 formed on the substrate 36, and a gate electrode 39 formed on the gate insulating film 38 constitute a selective transistor Tr. The selective transistor Tr and the MR element 1 form the one memory cell of the MRAM. The source region 37b is connected to another bit line 42 via a plug 41. Alternatively, the plug 35 may be provided under the lower electrode 33 without the extension electrode 34, and the lower electrode 33 may be connected directly to the plug 35. The bit lines 32 and 42, the electrodes 31 and 33, the extension electrode 34, and the plugs 35 and 41 are made of W, Al, AlCu, Cu, and the likes.

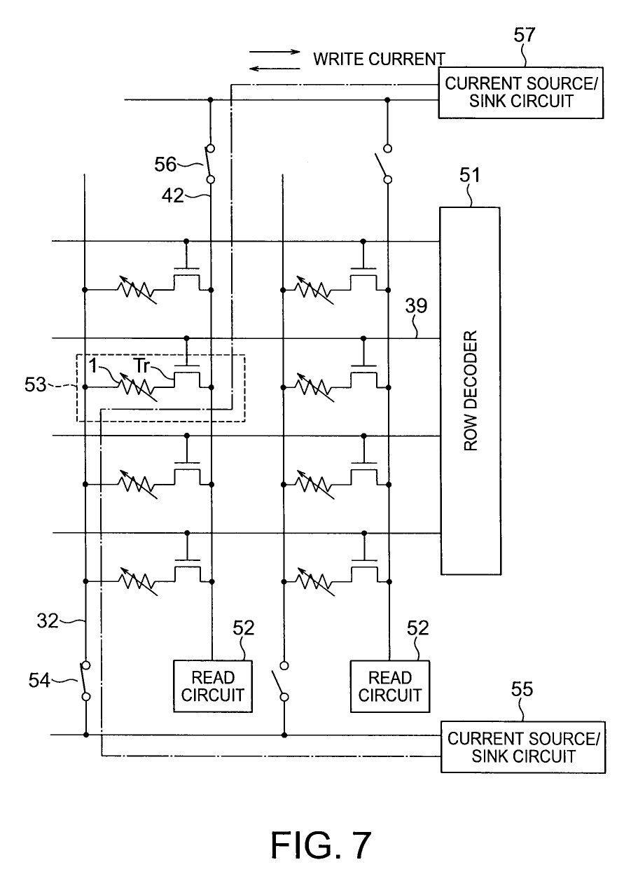

In the MRAM of this embodiment, memory cells each having the same structure as the memory cell shown in FIG. 6 are arranged in a matrix form, so as to form the memory cell array of the MRAM. FIG. 7 is a circuit diagram showing the principal components of the MRAM of this embodiment.

As shown in FIG. 7, memory cells 53 that are formed with MR elements 1 and selective transistors Tr are arranged in a matrix form. One end of each of the memory cells 53 arranged in the same column is connected to the same bit line 32, and the other end is connected to the same bit line 42. The gate electrodes (word lines) 39 of the memory cells 53 arranged in the same row are connected to one another, and are also connected to a row decoder 51.

The bit line 32 is connected to a current source/sink circuit 55 via a switch circuit 54 such as a transistor. The bit line 42 is connected to a current source/sink circuit 57 via a switch circuit 56 such as a transistor. The current source/sink circuits 55 and 57 supply write current (inversion current) to the connected bit lines 32 and 42, and remove the write current from the connected bit lines 32 and 42.

The bit line 42 is also connected to a read circuit 52. The read circuit 52 may be connected to the bit line 32. The read circuit 52 includes a read current circuit, a sense amplifier, and the likes.

At the time of writing, the switch circuits 54 and 56 connected to the memory cell on which writing is to be performed, and the selective transistor Tr are turned on, so as to form a current path that runs through the subject memory cell. One of the current source/sink circuits 55 and 57 functions as a current source, and the other one functions as a current sink, in accordance with the information to be written. As a result, the write current flows in the direction determined by the information to be written.

As for the write speed, it is possible to perform spin-injection writing with a current having a pulse width of several nanoseconds to several microseconds.

At the time of reading, a read current of such a small size as not to cause a magnetization reversal is supplied to the subject MR element 1 by a read current circuit in the same manner as in the case of writing. The read circuit 52 compares the current value or the voltage value determined by the resistance value in accordance with the magnetization state of the MR element 1, with a reference value. In this manner, the read circuit 52 decides the resistive state.

At the time of reading, the current pulse width should preferably be smaller than the current pulse width observed in a writing operation. Accordingly, write errors with the current at the time of reading can be reduced. This is based on the fact that the absolute value of the write current is larger when the pulse width of the write current is smaller.

As described so far, each of the embodiments of the present invention can provide a magnetoresistive element of a spin-transfer-torque writing type that requires only a low current to cause a magnetization reversal in a magnetization free layer having the high magnetization reversal energy required for retaining information, and also provide a magnetoresistive random access memory including the magnetoresistive element.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concepts as defined by the appended claims and their equivalents.

What is claimed is:

1. A magnetoresistive element comprising:
a first magnetization reference layer having magnetization perpendicular to a film plane, a direction of the magnetization being invariable in one direction;
a magnetization free layer having magnetization perpendicular to the film plane, a direction of the magnetization being variable;
a first intermediate layer provided between the first magnetization reference layer and the magnetization free layer;
a magnetic phase transition layer provided on an opposite side of the magnetization free layer from the first intermediate layer, the magnetic phase transition layer being magnetically coupled to the magnetization free layer, and being capable of bidirectionally performing a magnetic phase transition between an antiferromagnetic material and a ferromagnetic material; and
an excitation layer provided on an opposite side of the magnetic phase transition layer from the magnetization free layer, and causing the magnetic phase transition layer to perform the magnetic phase transition from the antiferromagnetic material to the ferromagnetic material,
the magnetization direction of the magnetization free layer being variable by flowing a current between the first magnetization reference layer and the magnetization free layer via the first intermediate layer.

2. The element according to claim 1, wherein:
the magnetic phase transition layer is made of an alloy containing Fe and Rh; and
the magnetic phase transition layer is expressed as Fe₁₋ₓRhₓ (0.3≦x≦0.7), which indicates relative proportions of Fe and Rh.

3. The element according to claim 1, wherein the magnetic phase transition layer is made of an alloy containing Fe, Rh, and at least one element A selected from the group consisting of V, Cr, Mn, Co, Ni, Cu, Ru, Pd, Ag, Os, Ir, Pt, and Au, and is expressed as Fe₁₋ₓ(Rh_{1-y}A_{y})ₓ (0.3≦x≦0.7, 0<y<1), which indicates relative proportions of Fe, Rh, and the element represented by “A”.

4. The element according to claim 1, wherein the magnetization free layer is a ferromagnetic film or a ferromagnetic film that contains at least one element selected from the group consisting of Fe, Co, and Ni, and at least one element selected from the group consisting of Pt and Pd.

5. The element according to claim 4, wherein the magnetization free layer has a face-centered tetragonal structure, and has a L1₀ ordered structure phase.

6. The element according to claim 5, wherein the magnetization free layer is orientated to the (001) plane.

7. The element according to claim 1, wherein the excitation layer is made of a material having specific resistance of 200 μΩcm or higher.

8. The element according to claim 1, wherein the magnetization direction of the magnetization free layer is variable by bidirectionally flowing the current between the first magnetization reference layer and the excitation layer via the phase transition layer.

9. A magnetoresistive element comprising:
a first magnetization reference layer having magnetization perpendicular to a film plane, a direction of the magnetization being invariable in one direction;
a magnetization free layer having magnetization perpendicular to the film plane, a direction of the magnetization being variable;
a first intermediate layer provided between the first magnetization reference layer and the magnetization free layer;
a magnetic phase transition layer provided on an opposite side of the magnetization free layer from the first intermediate layer, the magnetic phase transition layer being magnetically coupled to the magnetization free layer, and being capable of bidirectionally performing a magnetic phase transition between an antiferromagnetic material and a ferromagnetic material;
a second magnetization reference layer provided on an opposite side of the magnetic phase transition layer from the magnetization free layer, the second magnetization reference layer having magnetization perpendicular to the film plane, a direction of the magnetization being invariable in one direction and being antiparallel to the magnetization direction of the first magnetization reference layer;
a second intermediate layer provided between the magnetic phase transition layer and the second magnetization reference layer, and causing the magnetic phase transition layer to perform the magnetic phase transition from the antiferromagnetic material to the ferromagnetic material,
the magnetization direction of the magnetization free layer being variable by flowing a current between the first magnetization reference layer and the magnetization free layer via the first intermediate layer.

10. The element according to claim 9, wherein:
the magnetic phase transition layer is made of an alloy containing Fe and Rh; and
the magnetic phase transition layer is expressed as Fe₁₋ₓRhₓ (0.3≦x≦0.7), which indicates relative proportions of Fe and Rh.

11. The element according to claim 9, wherein the magnetic phase transition layer is made of an alloy containing Fe, Rh, and at least one element A selected from the group consisting of V, Cr, Mn, Co, Ni, Cu, Ru, Pd, Ag, Os, Ir, Pt, and Au, and is expressed as Fe₁₋ₓ(Rh_{1-y}A_{y})ₓ (0.3≦x≦0.7, 0<y<1), which indicates relative proportions of Fe, Rh, and the element represented by “A”.

12. The element according to claim 9, wherein the magnetization free layer is a ferromagnetic film or a ferrimagnetic film that contains at least one element selected from the group consisting of Fe, Co, and Ni, and at least one element selected from the group consisting of Pt and Pd.

13. The element according to claim 12, wherein the magnetization free layer has a face-centered tetragonal structure, and has a L1₀ ordered structure phase.

14. The element according to claim 13, wherein the magnetization free layer is orientated to the (001) plane.

15. The element according to claim 9, wherein the excitation layer is made of a material having specific resistance of 200 μΩcm or higher.

16. The element according to claim 9, wherein the magnetization direction of the magnetization free layer is variable by bidirectionally flowing the current between the first magnetization reference layer and the second magnetization reference layer via the second intermediate layer.

17. A magnetoresistive random access memory comprising
the magnetoresistive element according to claim 1 as a memory cell.

18. A magnetoresistive random access memory comprising:
a memory cell including the magnetoresistive element according to claim 1 and a transistor having one end series-connected to one end of the magnetoresistive element;
a first write current circuit connected to the other end of the magnetoresistive element; and
a second write current circuit connected to the other end of the transistor, and, in cooperation with the first write current circuit, flowing the current between the first magnetization reference layer and the excitation layer via the magnetic phase transition layer.

19. A magnetoresistive random access memory comprising
the magnetoresistive element according to claim 9 as a memory cell.

20. A magnetoresistive random access memory comprising:
a memory cell including the magnetoresistive element according to claim 9 and a transistor having one end series-connected to one end of the magnetoresistive element;
a first write current circuit connected to the other end of the magnetoresistive element; and
a second write current circuit connected to the other end of the transistor, and, in cooperation with the first write current circuit, flowing the current between the first magnetization reference layer and the second magnetization reference layer via the second intermediate layer.
